(19) United States
(12) Patent Application Publication
(10) Pub. No.: US 2012/0162400 A1
(43) Pub. Date: Jun. 28, 2012

(54) STEREOSCOPIC IMAGE DISPLAYING APPARATUS

(76) Inventors: Yuki Iwanaka, Tokyo (JP); Masahiro Baba, Yokohama-shi (JP); Io Nakayama, Yokohama-shi (JP)

(21) Appl. No.: 13/413,010

(22) Filed: Mar. 6, 2012

Related U.S. Application Data
(63) Continuation of application No. PCT/JP2009/066445, filed on Sep. 18, 2009.

(51) Int. Cl. H04N 13/04

(52) U.S. Cl. 348/54; 348/E13.036

(57) ABSTRACT

There is provided a stereoscopic image displaying apparatus that displays a stereoscopic image to a viewer wearing glasses, in which the image displaying unit has a plurality of display pixels, the correcting unit corrects gray levels of pixels of the image signal for the right eye or the left eye, the writing unit writes the image signal corrected by the correcting unit, into the display pixels of the image displaying unit, the timing controlling unit controls timing to open and close the right and the left of the glasses in accordance with timing of the writing by the writing unit, and the correcting unit corrects the gray levels of the pixels of the image signal in accordance with a difference between the timing of the writing by the writing unit and the timing to open and close the right and the left of the glasses.

### CROSS REFERENCE TO RELATED APPLICATIONS

This application is a continuation of International Application No. PCT/JP2009/066445, filed on Sep. 18, 2009, the entire contents of which is hereby incorporated by reference.

### FIELD

Embodiments relate to a stereoscopic image displaying apparatus that displays three-dimensional (3D) video images to viewers wearing special-purpose glasses, for example, by displaying video images from different viewpoints on the screen by a time dividing scheme.

### BACKGROUND

As a stereoscopic (three-dimensional) display, a time-dividing stereoscopic display that displays video images from multi-viewpoints on a screen by a time dividing scheme has been developed. As such a time-dividing stereoscopic display, there have been suggested a glasses type and an auto-stereoscopic method. In a display of the glasses type, special-purpose glasses are used to separate images for the left eye and images for the right eye. The glasses type is currently used for showing the stereoscopic film and the like. In a display of the auto-stereoscopic method, the backlight has directionality, to separate respective viewpoint images.

A stereoscopic image displaying apparatus of the time-dividing type has the problem of degrading image quality such as double images or blurring in 3D video images when the separation between left and right images becomes insufficient while the images are being displayed. Leakage of an image for the left eye into an image for the right eye or vice versa is called crosstalk (ghost).

For a liquid crystal type apparatus among stereoscopic image displaying apparatus of time-dividing types, it is desirable to alternately display left and right parallax images at a rate close to 120 times per second in order to prevent flickers on the images. However, to perform such high-speed displaying, the liquid crystal response speed is too low, and the separation between the left and right images becomes insufficient due to delays in liquid crystal responses. As a result, image quality will be degraded, causing problems such as double images or blurring in 3D video images.

JP-A 2006-157775 (Kokai) suggests a method of preventing crosstalk due to slow liquid crystal responses of a liquid crystal panel by comparing the gray levels of the previous image data with the gray levels of the latest image data, and making compensation so as to emphasize the changes in the gray levels of the latest image data. Meanwhile, Japanese Patent No. 3732775 suggests a method of preventing blurring in moving images due to delays in liquid crystal responses by extracting “unreached pixels” having liquid crystal response time later than the timing of light emission from the backlight, and correcting the written gray levels of the “unreached pixels” so as to be equal to the total of display luminance of the “unreached pixels” in one frame period.

However, in a time-dividing stereoscopic image displaying apparatus of the glasses type, not only delays in responses when images are displayed cause insufficient separation between left and right images, but also delays in responses in opening and closing of the glasses occurs. As a result, crosstalk occurs and adversely affects the quality of stereoscopic video images. Furthermore, the delays in opening and closing of the glasses might cause unevenness in luminance or a decrease in luminance. Also, in the case of a liquid crystal type apparatus among time-dividing stereoscopic image displaying apparatus of the glasses type, not only delays in liquid crystal responses of the panel but also delays in liquid crystal responses in the opening and closing of the liquid crystal shutter glasses are caused. This results in crosstalk, and adversely affects the image quality of stereoscopic video images. Furthermore, the delays in the opening and closing of the glasses might cause uneven luminance or a decrease in luminance.

Therefore, by the gray level corrections taking into account only the backlight luminance and the transmittances of the liquid crystals as in JP-A 2006-157775 (Kokai) and Japanese Patent No. 3732775, occurrences of crosstalk cannot be prevented as desired.

### BRIEF DESCRIPTION OF THE DRAWINGS

FIG. 1 is a diagram for explaining the outline of a stereoscopic image displaying apparatus according to a first embodiment;

FIG. 2 is a block diagram specifically showing the structure of the stereoscopic image displaying apparatus;

FIG. 3 is a diagram specifically showing the structure of the timing controlling unit;

FIG. 4 is a diagram specifically showing the structure of the gray level correcting unit;

FIG. 5 is a diagram showing an example of the corrected gray level table;

FIGS. 6A and 6B are schematic views for explaining an occurrence of crosstalk due to delays in liquid crystal responses of the liquid crystal panel;

FIGS. 7A through 7C are schematic views for explaining an occurrence of crosstalk due to delays in liquid crystal responses of the liquid crystal glasses;

FIG. 8 is a diagram showing double images due to crosstalk;

FIGS. 9A through 9C are diagrams for explaining liquid crystal responses, the backlight luminance, and responses of the right shutter of the glasses;

FIGS. 10A and 10B are diagrams for explaining the timing to write image signals, the shutter opening periods, and liquid crystal responses;

FIGS. 11A and 11B are diagrams showing the relationship between the timing to write image signals and the opening and closing periods of the shutters;

FIG. 12 is a block diagram of a stereoscopic image displaying apparatus according to a second embodiment;

FIG. 13 is a diagram showing the relationship between the timing to write image signals and the timing of light emission from the backlight;

FIGS. 14A and 14B are diagrams showing the quantities of light in a vertical displaying position P2 with respect to a time axis according to the second embodiment; and

FIGS. 15A through 15C are schematic views for explaining input images and displayed images in stereoscopic image displaying apparatus.

### DETAILED DESCRIPTION

According to an embodiment, there is provided a stereoscopic image displaying apparatus that displays a stereoscopic image to a viewer wearing glasses, including: a correcting unit, an image displaying unit, a writing unit and a timing controlling unit.

The image displaying unit has a plurality of display pixels into which an image signal can be written.

The correcting unit corrects gray levels of pixels of the image signal for the right eye or the left eye.

The writing unit writes the image signal corrected by the correcting unit, into the display pixels of the image displaying unit.

The timing controlling unit controls timing to open and close the right and the left of the glasses in accordance with timing of the writing by the writing unit.

The correcting unit corrects the gray levels of the pixels of the image signal in accordance with a difference between the timing of the writing by the writing unit and the timing to open and close the right and the left of the glasses.

Hereinafter, embodiments will be described with reference to the accompanying drawings. It should be noted that structures and procedures that perform similar operations are denoted by the common reference numerals, and the same explanation will not be repeated.

### First Embodiment

A stereoscopic image displaying apparatus of this embodiment is a liquid crystal display for stereoscopically displaying images in a time-dividing scheme. A stereoscopic displaying apparatus switches and displays an image for the left eye and an image for the right eye, each image having parallax, and alternately opens and closes the left and right shutters for special-purpose glasses (glasses that control the light transmission for the right eye and the left eye by opening and closing the shutters) so that the viewer alternately views the image for the left eye and the image for the right eye. Images displayed on the stereoscopic displaying apparatus are two-dimensional images. However, images with parallax for the left eye and the right eye of the viewer are displayed separately from each other, so that stereoscopic viewing utilizing the binocular parallax is realized.

Time-dividing schemes include a liquid crystal shutter glasses scheme, a polarizing filter glasses scheme, an RGB waveband-dividing filter glasses scheme. In this embodiment, a time dividing scheme using glasses of the liquid crystal shutter glasses scheme is described as an example. The time dividing scheme may be either of a field sequential type or a frame sequential type. In this embodiment, the time dividing scheme of the frame sequential type will be explained.

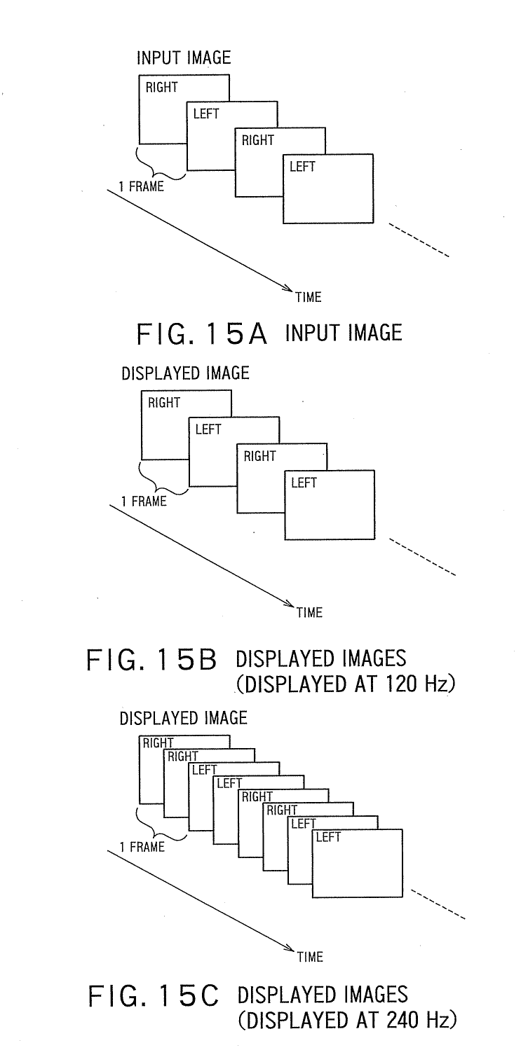

FIGS. 15A through 15C are schematic views for explaining input images and displayed images in a stereoscopic image displaying apparatus. As shown in FIG. 15A, a unit of image signals for the left eye (for the right eye) to realize stereoscopic viewing is regarded as one frame. FIG. 15B illustrates a case where images are displayed at 120 Hz, and FIG. 15C illustrates a case where images are displayed at 240 Hz.

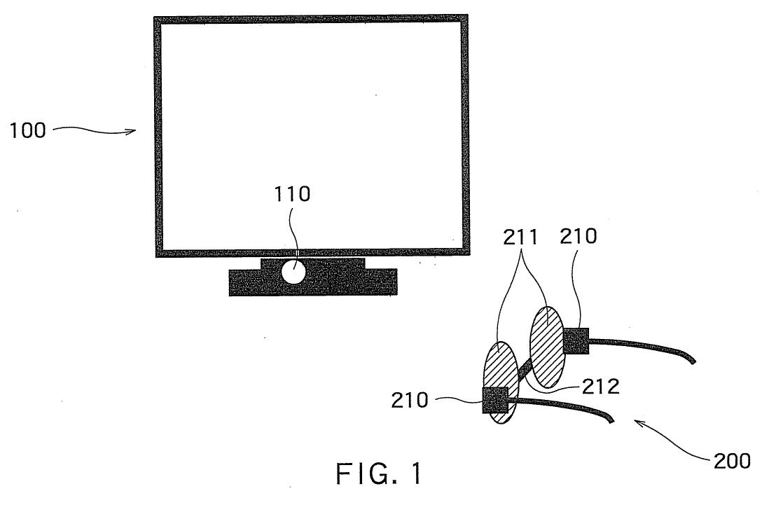

FIG. 1 is a diagram for explaining an outline of a stereoscopic image displaying apparatus 100 of this embodiment.

The stereoscopic image displaying apparatus 100 switches and displays a plurality of images from different viewpoints (hereinafter referred to as “parallax images”) by a time dividing scheme. The stereoscopic image displaying apparatus 100 has a transmitting unit 110 to transmit switching signals by the frame. The transmitting unit 110 transmits the switching signals to glasses 200 through infrared rays or the like. The switching signals are indicative of the timing to switch liquid crystal shutters 211. It should be noted that the stereoscopic image displaying apparatus 100 is a liquid crystal display including a backlight that emits light to the back face of the liquid crystal panel.

The glasses 200 include the left and right liquid crystal shutters 211, a receiving unit 212 that receives the switching signals transmitted from the transmitting unit 110, and driving units 210 that drive opening and closing of the left and right liquid crystal shutters 211 in synchronization with the switching signals. The driving units 210 control the opening and closing of the left and right liquid crystal shutters 211 so that images for the right eye and images for the left eye are input alternately in terms of time. With this arrangement, parallax images with parallax are alternately input to the right eye and the left eye of the viewer in terms of time. As the parallax images are alternately input to the right eye and the left eye, the viewer can recognize video images displayed two-dimensionally on the stereoscopic image displaying apparatus 100, as stereoscopic video images.

Communications between the transmitting unit 110 of the stereoscopic image displaying apparatus 100 and the receiving unit 212 of the glasses 200 are not limited to infrared communications, and may be communications using other wireless signals or communications using wired signals via a signal cable or the like.

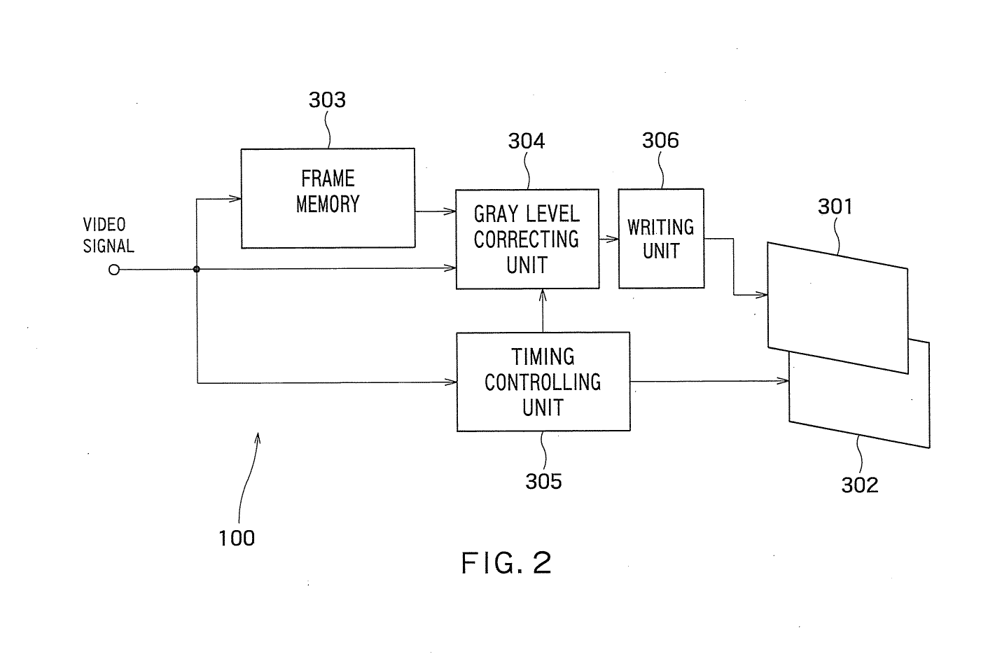

FIG. 2 is a block diagram specifically showing the structure of the stereoscopic image displaying apparatus 100. Video signals (image signals) indicating two-dimensional parallax images corresponding to each parallax of the right eye and the left eye are input to this apparatus from an external device (such as a controller IC, a recording medium, or a network) which is not shown.

The stereoscopic image displaying apparatus 100 includes a liquid crystal displaying unit (a liquid crystal panel) 301, a backlight 302, a frame memory (a storage) 303, a gray level correcting unit (a correcting unit) 304, a writing unit 306, and a timing controlling unit 305.

Image signals transmitted from a controller IC (not shown) are input to the frame memory 303, the gray level correcting unit 304, and the timing controlling unit 305.

The frame memory 303 is a memory circuit that holds image signals of at least one frame. The frame memory 303 holds image signals transmitted from the controller IC (not shown) for one frame period, and then outputs the image signals to the gray level correcting unit 304. Therefore, the image signals of the “n”th (“n” being an integer of 2 or greater) frame and the image signals of the “n−1”th frame are input to the gray level correcting unit 304 at the same time.

Lighting of the backlight 302 is controlled by the timing controlling unit 305, and the backlight 302 has a non-emission period and an emission period in one frame period. The backlight 302 emits light during the emission period, and does not emit light during the non-emission period.

The liquid crystal displaying unit 301 has liquid crystal pixels (displaying pixels) into which image signals can be written. The liquid crystal displaying unit 301 receives image signals to be written into the liquid crystal pixels by the writing unit 306. The liquid crystal displaying unit 301 displays images by modulating the light emission from the backlight 302 in accordance with the gray levels of the image signals written into the liquid crystal pixels.

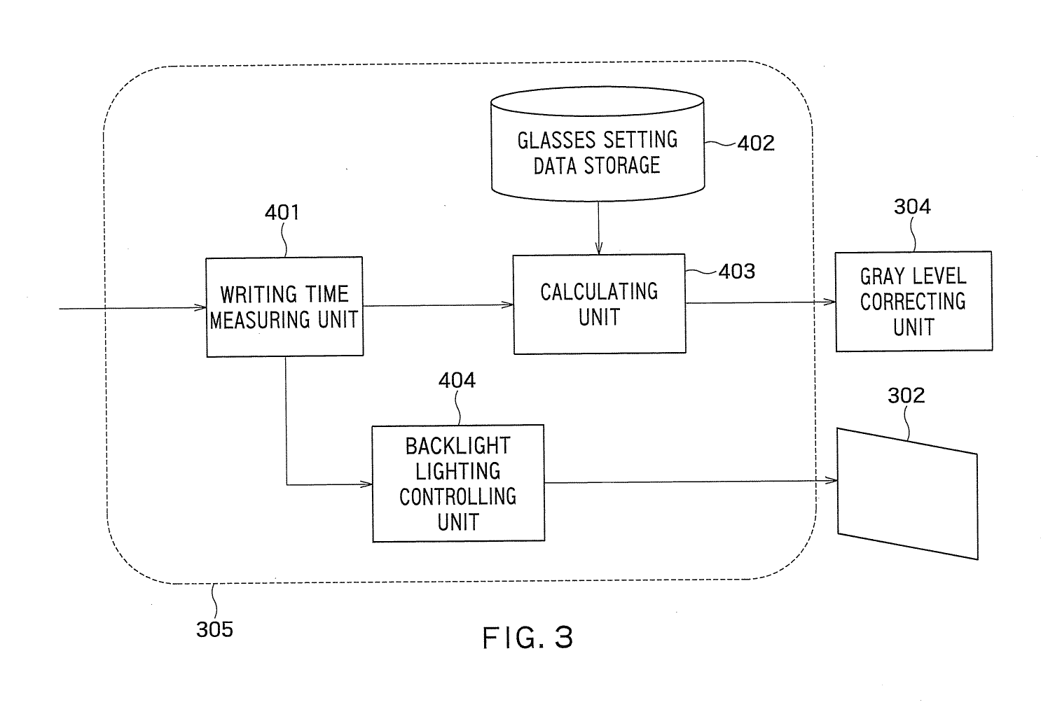

The timing controlling unit 305 controls the timing of light emission from the backlight 302 and the timing to open and close the left and right liquid crystal shutters of the liquid crystal glasses in accordance with the timing to write image signals into the liquid crystal displaying unit 301 (the writing time). The timing controlling unit 305 also calculates the time difference between the timing to switch between opening and closing of the left and right liquid crystal shutters (the glasses switching time) and the timing to perform writing on a processing-target pixel (the writing time), and outputs the time difference data to the gray level correcting unit 304. The structure of the timing controlling unit 305 will be specifically described later, with reference to FIG. 3.

The gray level correcting unit 304 corrects the gray level of the image signal corresponding to the processing-target pixel (of the “n”th frame), based on the image signals of the “n”th frame, the image signals of the “n−1”th frame held in the frame memory 303 for one frame period, and the time difference output from the timing controlling unit 305. The gray level correcting unit 304 sequentially selects the respective liquid crystal pixels of the liquid crystal displaying unit 301 as the processing-target pixel, and performs gray level corrections on the respective corresponding image signals (of the “n”th frame). The gray level correcting unit 304 will be described later in detail.

The writing unit 306 writes the image signals having the corrected gray levels calculated by the gray level correcting unit 304, into the corresponding liquid crystal pixels in the liquid crystal displaying unit 301.

FIG. 3 is a diagram specifically showing the structure of the timing controlling unit 305.

The timing controlling unit 305 includes a writing time measuring unit 401, a glasses setting data storage 402, a calculating unit 403, and a backlight lighting controlling unit 404.

The writing time measuring unit 401 calculates the time when writing is performed on the processing-target pixel (the writing time), where the time when writing is performed on the uppermost line of the image signals of one frame or, more specifically, a first pixel on the uppermost line (hereinafter referred to as the “reference time”) is set as “time 0.” The writing time measuring unit 401 then outputs the calculated writing time to the calculating unit 403.

The glasses setting data storage 402 stores beforehand a glasses switching time with respect to the reference time.

The calculating unit 403 reads the glasses switching time from the glasses setting data storage 402, and calculates the difference between the writing time measured by the writing time measuring unit 401 and the glasses switching time read from the glasses setting data storage 402. The calculating unit 403 then outputs the calculated difference to the gray level correcting unit 304. It should be assumed that there are cases where the writing time is before or after the glasses switching time.

Based on the reference time, the backlight lighting controlling unit 404 controls the timing to light the backlight 302. For example, the backlight lighting controlling unit 404 controls the backlight 302 to emit light for a certain period after a predetermined time from the reference time.

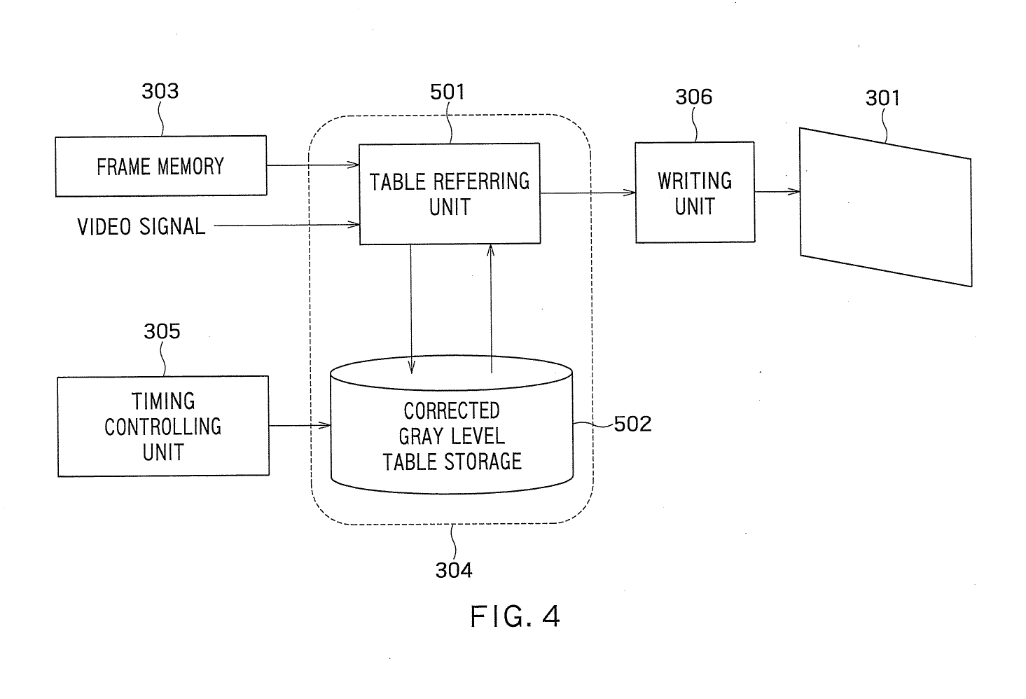

FIG. 4 is a diagram specifically showing the structure of the gray level correcting unit 304.

As described above, the gray level correcting unit 304 corrects the gray level of the processing-target pixel (i.e., corrects the gray level such that an inter-frame change in gray level is emphasized), based on the image signals of the “n”th frame, the image signals of the “n−1”th frame, and the time difference (the difference between the writing time and the glasses switching time) that is output from the timing controlling unit 305.

Specifically, the gray level correcting unit 304 corrects the gray level of the processing-target pixel, so that the difference between a predetermined expectation value and the total integrated intensity becomes smallest, wherein the total integrated intensity is obtained for the processing-target pixel by integrating products of (a) the liquid crystal transmittance of the processing-target pixel, (b) the backlight luminance, and (c) the transmittances of the grasses (each of the left and right liquid crystal shutters) in a predetermined period and summing (or adding) up the integrated products for the left and right liquid crystal shutters. For ease of explanation, the predetermined period is the period of the current one frame in this embodiment. However, the predetermined period may be the period of the continuous two frames consisting of the current frame and the previous frame, or a period of more than two frames. The predetermined expectation value represents the total integrated intensity, for example, in a case where there are no delays in the liquid crystal panel responses or in a case of a step response. The principles of such gray level corrections will be described later.

The predetermined period can be arbitrarily set as described above. In the case of moving images, the crosstalk preventing effect can be made greater by prolonging the period. In such a case, the frame memory may be designed to hold more than one frame. However, the calculation of corrected gray levels would become complicated, and the capacity of the frame memory would become larger. Therefore, the period should be determined in accordance with the limit of the calculation cost and the limit of the circuit size. It should be noted that, in a case where a field sequential method is used, the period may be arbitrarily set as one or more fields.

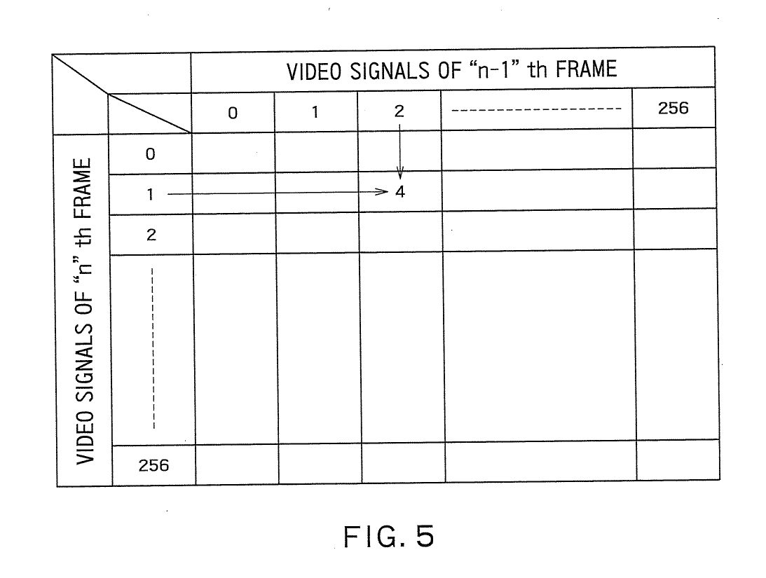

Here, to shorten the calculating time of the gray level correcting unit 304, a corrected gray level table in which the gray levels of the “n”th frame, the gray levels of the “n−1”th frame, and corrected gray levels are associated with one another may be created in advance for a plurality of time differences (the differences between writing times and the glasses switching time). Calculations may be performed based on this table. FIG. 5 shows an example of the corrected gray level table.

That is, the corrected gray level table for each of the time differences is stored into a corrected gray level table storage 502, and a table referring unit 501 identifies the table corresponding to the time difference input from the timing controlling unit 305 in the corrected gray level table storage 502. In the identified table, the table referring unit 501 searches for the corrected gray level based on the gray level of the processing-target pixel in the “n−1”th frame and the gray level of the processing-target pixel in the “n”th frame. The writing unit 306 then writes an image signal having the searched corrected gray level into the corresponding liquid crystal pixel in the liquid crystal panel 301. It should be noted that a gray level of the “n”th frame and a gray level of the “n−1”th frame are used, because the response of liquid crystals is not determined only by the gray level of the current frame but is determined by the relationship with the gray level of the previous frame. When integrating is performed over a period of a plurality of frames, tables may be created with the use of the gray levels of the “n−2”th frame and earlier. That is, where the predetermined period is “N”, tables in which the gray levels of image signals of 1 to “N” frame input earlier are associated with the gray levels of the image signals of the current frame may be created (“N” being an integer of 1 or greater).

In the following, the principles of gray level corrections to be performed by the gray level correcting unit 304 are described.

First, the principles of crosstalk occurrences are described.

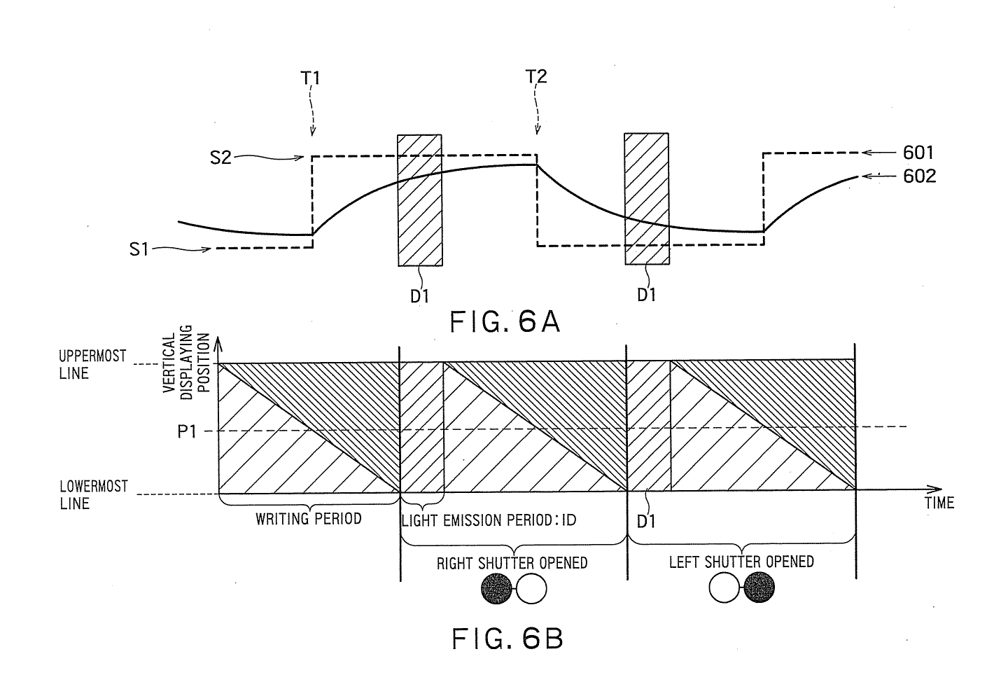

FIGS. 6A and 6B are schematic views for explaining an occurrence of crosstalk due to delays in liquid crystal responses in the liquid crystal panel 301. More specifically, FIG. 6B shows the relationship among the period of writing into the liquid crystal panel, the backlight emission period, and the shutter opening period. FIG. 6A shows liquid crystal responses at a vertical displaying position P1 of the liquid crystal panel illustrated in FIG. 6B.

In FIG. 6B, a backlight emission period D1 is between the time of writing on the lowermost line of the liquid crystal panel and the time of writing on the uppermost line of the next frame. Also, each shutter opening period of the liquid crystal glasses is between the start time of backlight emission and the start time of the next light emission.

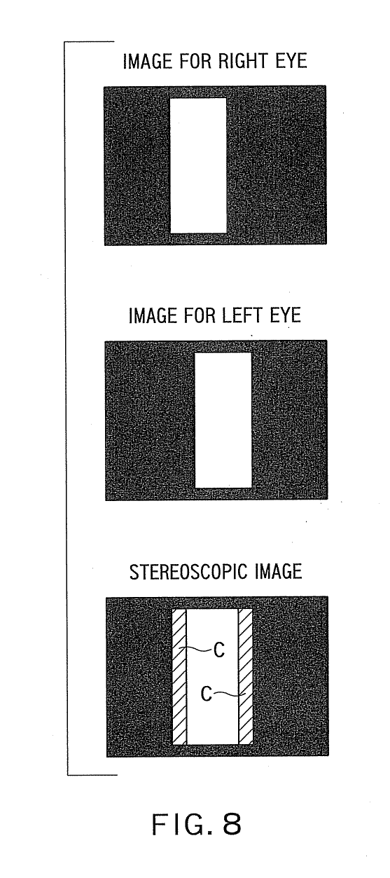

FIG. 6A illustrates the liquid crystal responses observed in a case where two gray levels S1 and S2 are alternately written. A response 601 is an ideal response (a step response) of liquid crystals. When writing starts, the ideal response 601 changes to a desired target value without delay. For example, when writing starts at time T1, the response 601 changes to the target value S2 without delays. When writing starts at time T2, the response 601 changes to the target value S1 without delays. However, the actual response is a response 602 with delays. Therefore, in the vertical displaying position P1, the backlight emits light before each liquid crystal response is completed (in the response 602, the liquid crystal response completes before it reaches the target value). As a result, in a case of a displayed image in which a box having the gray level of 200 protrudes from a background having the gray level of 20 as shown in FIG. 8, the viewer senses double images C due to crosstalk on the left and right sides of the box.

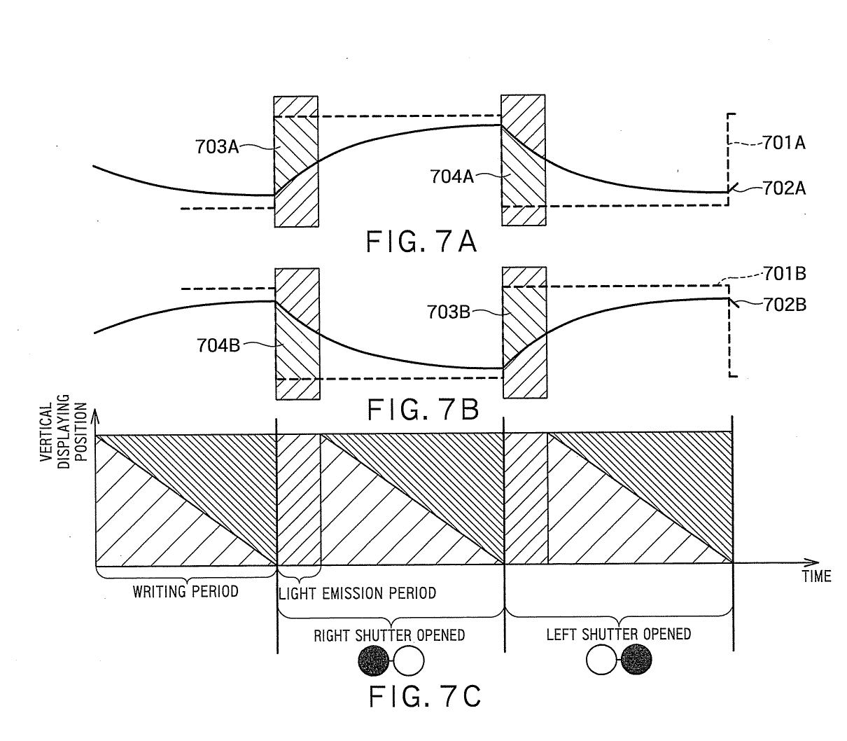

FIGS. 7A through 7C are schematic views for explaining an occurrence of crosstalk due to delays in liquid crystal responses of the liquid crystal glasses.

FIG. 7A shows a response of the right shutter of the liquid crystal glasses, and FIG. 7B shows a response of the left shutter of the liquid crystal glasses. FIG. 7C shows the relationship among the period of writing into the liquid crystal panel, the backlight emission period, and the shutter opening period (the same diagram as that of FIG. 6B).

As shown in FIG. 7C, opening of the right shutter and opening of the left shutter are alternately repeated, and the left and right shutters are not closed at the same time.

In FIGS. 7A and 7B, responses 701A and 701B are ideal responses (step responses) of the shutters of the glasses. According to the responses 701A and 701B, opening and closing are performed without delays at the timing to switch between opening and closing. However, actual responses are responses 702A and 702B with delays. Therefore, when the shutters are opened, the luminance decreases due to deficits 703A and 703B. When the shutters are closed, crosstalk might occur due to excesses 704A and 704B. As a result, the double images due to crosstalk shown in FIG. 8 are sensed as in the case where there are delays in liquid crystal responses of the liquid crystal panel.

To solve the problems presented in FIGS. 6 and 7, liquid crystal materials having high response speeds should be used for the liquid crystal panel and the liquid crystal glasses. However, such liquid crystal materials are still in a development stage. Also, such liquid crystal materials are costly, and therefore, are difficult to be used as manufacturing products. Even in cases where the scanning time or the light emission period is shortened, the circuit load would become larger, or the display luminance would become lower. In view of this, this embodiment solves those problems through the above described gray level correcting procedures to be performed by the gray level correcting unit 304. In the following, the principles of the gray level correcting procedures are described.

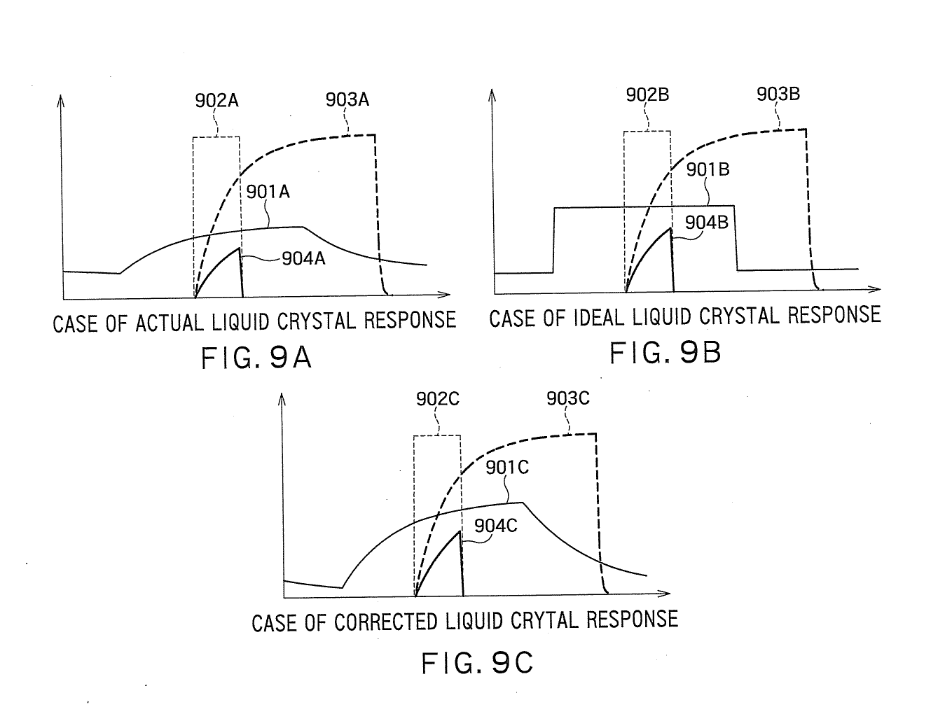

FIGS. 9A through 9C are schematic views for explaining the liquid crystal responses of the liquid crystal panel, the backlight luminance, and the responses of the right shutter of the glasses (when opened) in the vertical displaying position P1 of FIG. 6B.

FIG. 9A shows the responses in a case where the liquid crystal panel displays images without a correction performed on the gray levels of input image signals. FIG. 9B shows the responses that reach the target values without delays in liquid crystal responses (that is, the step responses that are the ideal responses). FIG. 9C shows the responses in a case where the liquid crystal panel displays images with corrected gray levels calculated by the gray level correcting unit 304.

In FIG. 9A, reference numeral 901A denotes the liquid crystal response (without a gray level correction), reference numeral 902A denotes the backlight luminance, reference numeral 903A denotes the shutter response of the glasses, and reference numeral 904A denotes the product of the liquid crystal response 901A, the backlight luminance 902A, and the shutter response of the glasses 903A. The energy equivalent to the area surrounded by the response 904A (the integrated intensity that is the value of the integral of the product) is input to the eye of the viewer.

In FIG. 9B, the backlight luminance 902B and the shutter response of the glasses 903B are the same as those shown in FIG. 9A, but the liquid crystal response 901B is an ideal response without delays. Reference numeral 904B denotes the product of the liquid crystal response 901B, the backlight luminance 902B, and the shutter response of the glasses 903B. The energy equivalent to the area surrounded by the response 904B (the integrated intensity) is larger than the energy equivalent to the area surrounded by the response 904A (the integrated intensity) shown in FIG. 9A.

FIGS. 9A and 9B show the relationships in an opening period of the right shutter, but a closing response of the left shutter occurs at the same time as the opening response of the right shutter. Therefore, the energy equivalent to the integral of the product of the left shutter closing response, the liquid crystal response 901A, and the backlight luminance 902A (the integrated intensity) is also input to the eye of the viewer.

In this embodiment, a gray level correction is performed on each image signal, so that the integrated intensity achieved after the gray levels are corrected (i.e., the total integrated intensity obtained by summing up the integrated intensity corresponding to the right-eye shutter and the integrated intensity corresponding to the left-eye shutter) becomes closest to the integrated intensity achieved in the ideal case shown in FIG. 9B (i.e., the total integrated intensity obtained by summing up the integrated intensity corresponding to the right-eye shutter and the integrated intensity corresponding to the left-eye shutter). For example, a gray level of an image signal is corrected so that the difference between the total integrated intensity after the correction and the total integrated intensity in the ideal case illustrated in FIG. 9B becomes smallest or does not exceed a threshold value.

In FIG. 9C, a response 901C denotes the liquid crystal response in a case where a gray level correction of this embodiment is performed, and a response 904C denotes the integrated intensity (corresponding to the right-eye shutter) based on the gray level correction. A backlight luminance 902C and a response of the right shutter of the glasses 903C are the same as those shown in FIGS. 9A and 9B. By the gray level correction of this embodiment, the difference between the total integrated intensity in the case of the correction being made and the total integrated intensity in the ideal case (the expectation value) becomes equal to or smaller than the threshold value. In this manner, the viewer wearing the liquid crystal glasses can be made to view high-quality stereoscopic images, with crosstalk occurrences being greatly reduced.

Based on the above described principles, the gray level correcting unit performs gray level corrections. That is, the gray level of each pixel in an image to be written is compared with the gray level of each corresponding pixel in the previous image stored in the frame memory, and changes in the gray level are calculated. Based on the changes in gray level, the gray levels of the image of the “n”th frame are corrected in accordance with the difference between the glasses switching time and the writing time.

Specifically, a corrected gray level is calculated so that the difference between the predetermined expectation value and the total integrated intensity becomes smallest, the total integrated intensity being obtained by integrating the products of (a) the liquid crystal transmittance of the processing-target pixel, (b) the backlight luminance, and (c) the transmittances of the glasses (the left and right shutters) and summing up the integrated products. It should be noted that the backlight lighting period, the backlight luminance, the liquid crystal writing period, the shutter opening period of the glasses, and the respective responses of the left and right shutters of the glasses are determined in advance. A liquid crystal response of the liquid crystal panel can be calculated from the gray levels of the previous frame, the gray levels of the next frame, and the liquid crystal writing period, for example. In view of this, a corrected gray level that minimizes the difference from the expectation value or makes the difference from the expectation value equal to or smaller than the threshold value can be calculated in accordance with the above described time difference and the combination of the gray levels of the “n−1”th frame and the “n”th frame. It should be noted that, in a case where the present invention is applied to an apparatus other than a liquid crystal display, display luminance of a display panel of the apparatus should be used, instead of the product of the liquid crystal transmittance and the backlight luminance.

To reduce calculations, it is also possible to use a table as described above. In that case, the corrected gray levels on each combination of the gray levels of the “n−1”th frame and the “n”th frame are calculated beforehand for each time difference between the glasses switching time and the writing time, and those corrected gray levels are stored as tables into the corrected gray level table storage 502. The table corresponding to the difference output from the timing controlling unit 305 is identified, and the corrected gray level corresponding to the combination of the gray levels of the “n−1”th frame and the “n”th frame are obtained from the table. If the predetermined period involves more than two frames, the gray levels of the “n−2”th frame and previous frames may be combined with those of the “n−1”th frame and the “n”th frame.

In this embodiment described above, the image displaying unit includes a liquid crystal displaying unit and a backlight. However, crosstalk can be prevented in the same manner as above in any image displaying unit that has an insufficient separation of right and left images due to delays in image displaying. Therefore, the embodiment can be applied to a displaying unit of any type other than a liquid crystal displaying unit.

It should be noted that the stereoscopic image displaying apparatus 100 according to this embodiment can also be used for displaying 2D images. In that case, the operations of the frame memory 303 holding image data for a predetermined period and the gray level correcting unit 304 may be bypassed, and image signals may be output directly to the liquid crystal displaying unit 301. Meanwhile, the timing controlling unit 305 may measure the writing time of each input image signal, and only performs the operation to control the lighting of the backlight 302.

### First Modification of the First Embodiment

### Where the Backlight is Always on

In the first embodiment, the backlight is made to switch between a non-emission period and an emission period in each one frame period. In a first modification, on the other hand, the backlight is always on, and a black image is inserted between the image for the left eye and the image for the right eye.

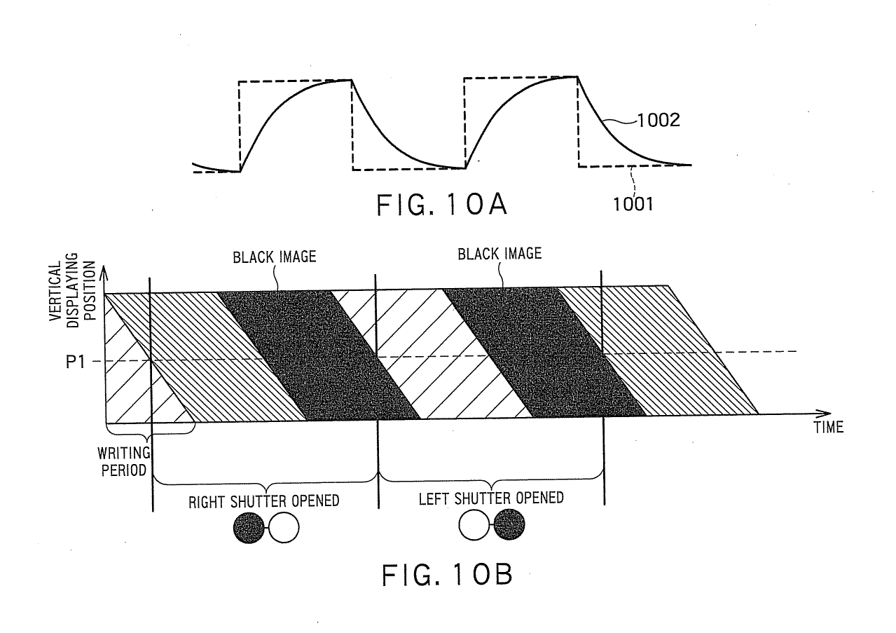

FIG. 10B is a timing chart showing the relationship between the writing of image signals into the liquid crystal displaying unit 301 and the opening periods of the shutters of the glasses. FIG. 10A shows liquid crystal responses in the vertical displaying position P1. In FIG. 10A, the dashed line indicates an ideal response 1001, and the solid line indicates a response 1002 with delays in an actual case. In this example, the backlight is always on.

In the case described below, the timing to switch the shutters of the glasses is set so as to be synchronized with the timing to write an image signal for the left eye or the right eye in the vertical displaying position P1. By inserting a black image as shown in the drawing, crosstalk does not occur in the vertical displaying position P1. In other vertical displaying positions, however, the timing to write a video image and the timing to switch the shutters of the glasses are out of synchronization, and therefore, crosstalk might occur. Therefore, in the first modification, crosstalk can be prevented by performing the same corrections as those performed in the first embodiment.

### Second Modification of the First Embodiment

### Where the Opening Periods of the Glasses are Set to be Shorter

As a second modification of the first embodiment, an example case where the backlight is always on, and there are periods during which the left and right shutters of the glasses are both closed at the same time is described.

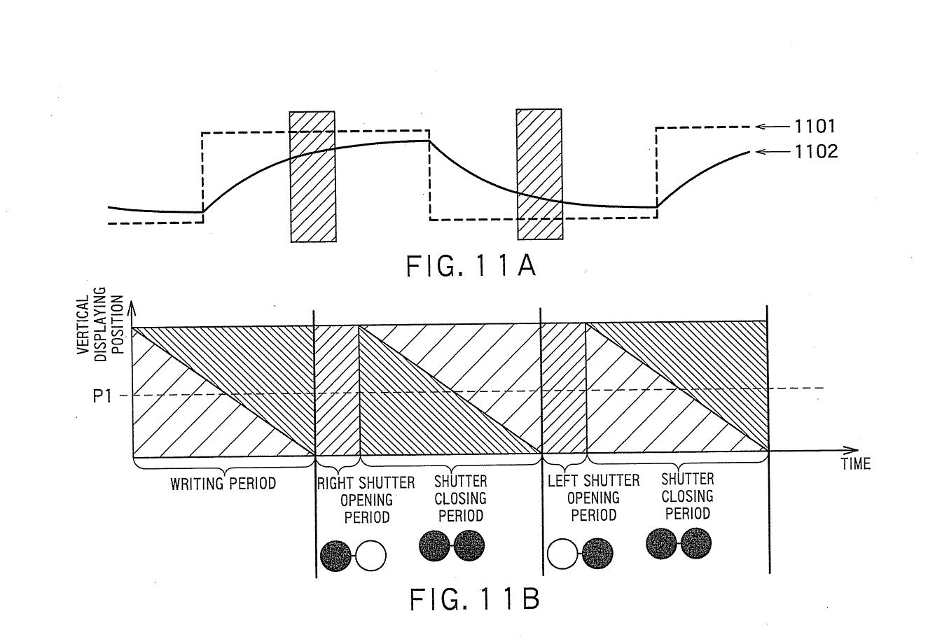

FIGS. 11A and 11B are timing charts showing the relationship between the writing of image signals into the liquid crystal displaying unit 301 and the opening and closing periods of the shutters of the glasses. In this example, the backlight is always on.

In this case, there are delays in liquid crystal responses as in the first embodiment. Therefore, the shutters of the glasses might open before a liquid crystal response is completed. This results in crosstalk. Also, there are delays in responses of the shutters of the glasses. This also results in crosstalk. In view of this, crosstalk can also be prevented in the second modification by performing the same corrections as those performed in the first embodiment.

In the second modification, the case was described where the backlight is always on. However, the backlight may be made to switch between a non-emission period and an emission period. In that case, when the backlight is switched off during a period in which the left and right shutters of the glasses are both closed, the power consumption can be reduced without a decrease in the screen luminance.

### Second Embodiment

In this embodiment, the backlight has a structure in which horizontal light emitting units are adjacently arranged along the vertical direction of the screen. The backlight to be described is a scan backlight type that sequentially switches on and off the respective light emitting units in one frame period.

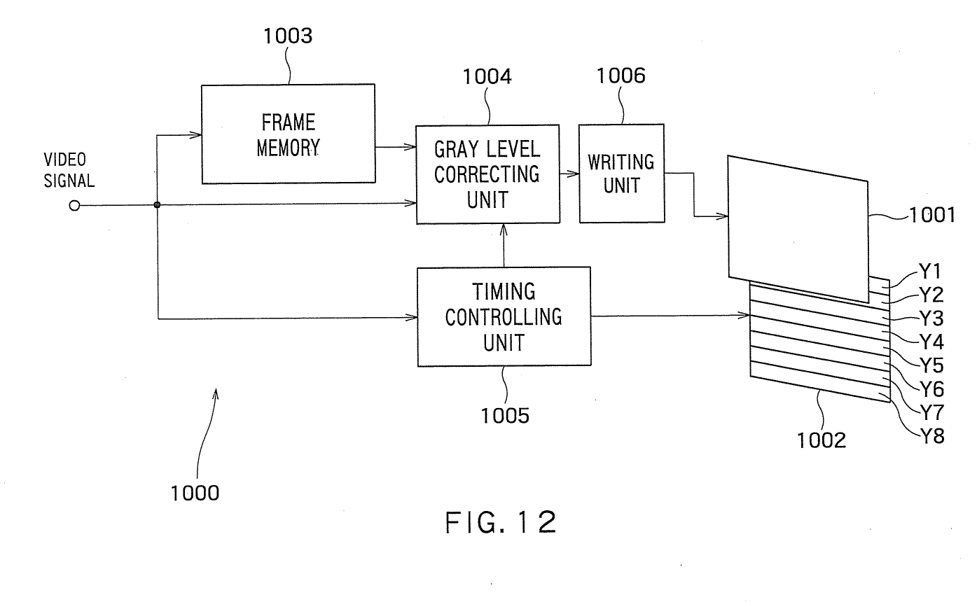

FIG. 12 is a block diagram of a stereoscopic image displaying apparatus 1000 according to this embodiment.

A backlight 1002 includes eight light emitting units Y1 through Y8 extending in the horizontal direction of the screen. The light emitting units Y1 through Y8 are adjacently arranged along the vertical direction of the screen. The light emitting units Y1 through Y8 can be regarded as corresponding to respective divided regions obtained by dividing the backlight of FIG. 2 into two or more in the vertical direction. Each of the light emitting units Y1 through Y8 has a non-emission period and an emission period in one frame period. The emission periods of the respective light emitting units Y1 through Y8 vary, but the durations of the respective periods are the same. Each of the light emitting units Y1 through Y8 has timing of light emission controlled by a timing controlling unit 1005 so that the respective light emitting units Y1 through Y8 are sequentially switched and lighted in one frame period. The respective light emitting units Y1 through Y8 are associated with different regions (regions facing the light emitting units) of a liquid crystal displaying unit 1001. A frame memory 1003, a writing unit 1006, and the liquid crystal displaying unit 1001 have the same structures as those of the first embodiment with the same names. A gray level correcting unit 1004 has its operations expanded in accordance with the above described modifications made to the structure of the backlight. In the following, the expanded operations will be mainly described.

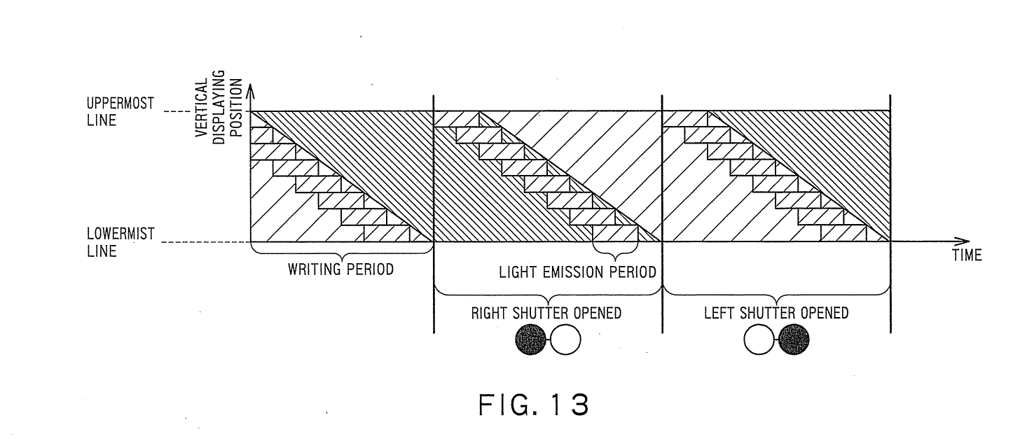

FIG. 13 is a timing chart showing the relationship between the writing of image signals into the liquid crystal displaying unit 1001 and the timing of light emission from the backlight 1002. Each opening period of the shutters of the glasses is between the start time of light emission from the uppermost light emitting unit Y1 of the backlight 1002 and the start time of the next light emission from the uppermost light emitting unit Y1.

In the backlight of the entire surface emission type described in the first embodiment, the time from a start of writing to lighting of the backlight becomes shorter in lower writing positions of the screen of the liquid crystal displaying unit (see FIG. 6B). In a case where the scan backlight method of this embodiment is used, on the other hand, each liquid crystal response time can last longer than that by the entire surface emission method, even in the lower positions of the screen, as can be seen from the drawing. Therefore, in a case where the scan backlight method is used (where lighting is performed by the scan backlight method without gray level corrections), crosstalk can be made less frequent than that in a case where the entire surface emission method is used (where lighting is performed by the entire surface emission method without gray level corrections). However, even where the scan backlight method is used, crosstalk still occurs when a liquid crystal response is not completed before each light emitting unit starts emitting light, as in the case of the entire surface emission method. Also, delays in responses of the liquid crystal glasses also cause crosstalk as in the first embodiment.

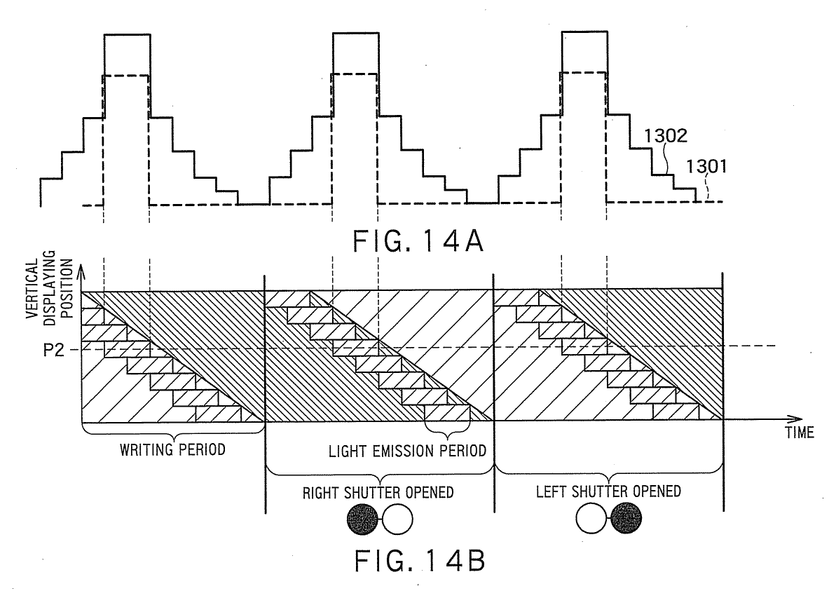

In a case where the scan backlight method is used, crosstalk may be reduced by performing the same gray level corrections as those of the first embodiment on each processing-target pixel, based on the emission luminance of each corresponding light emitting unit. By the scan backlight method, however, the processing-target pixels are illuminated not only with the light from each corresponding light emitting unit but also with the light leaking from the adjacent light emitting units, even before and after the emission period of each corresponding light emitting unit. Therefore, a sufficient decrease in crosstalk is not achieved, unless corrections are performed by taking this point into account. Referring now to FIGS. 14A and 14B, this aspect will be described in greater detail.

FIG. 14B is the same diagram as FIG. 13, and FIG. 14A shows the quantities of light in a vertical displaying position P2 with respect to a time axis (extending in a transverse direction along the paper sheet plane). An ideal response 1301 indicated by the dashed line shows that light enters a processing-target pixel only when the corresponding light emitting unit is emitting light, and light does not enter when the corresponding light emitting unit is not emitting light. However, an actual response 1302 indicated by the solid line shows that there exists incident light from adjacent light emitting units even when the corresponding light emitting unit is not emitting light. Such light leakage causes crosstalk.

In view of this, the gray level correcting unit 1004 of this embodiment performs gray level corrections on the input image signal, taking into account the distribution of the light leaking from the adjacent light emitting units. Specifically, when determining the integrated intensity with respect to the processing-target pixel, the gray level correcting unit 1004 uses, the backlight luminance, a total light intensity input to the processing-target pixel from each light emitting unit, based on the light distribution obtained when light is emitted from each light emitting unit to the liquid crystal displaying unit. The light distribution obtained when light is emitted from each light emitting unit to the liquid crystal display is determined in advance.

It should be noted that, like the stereoscopic image displaying apparatus of the first embodiment, the stereoscopic image displaying apparatus of this embodiment can display 2D images. In that case, the operations of the frame memory 1003 and the gray level correcting unit 1004 are bypassed, and the image signal are output directly to the liquid crystal displaying unit 1001. Meanwhile, the timing controlling unit 1005 measures the writing time, and only performs the operation to control the lighting of the backlight 1002.

In this embodiment, crosstalk is reduced by gray level corrections taking light leakage into account. However, partitions to prevent light leakage between the light emitting units may be provided as an alternative method, and gray level corrections can be performed in the same manner as in the first embodiment. In that case, attention should be paid to the uneven luminance of the screen when a 2D image is displayed.

1. A stereoscopic image displaying apparatus that displays a stereoscopic image to a viewer wearing glasses, comprising:
an image displaying unit having a plurality of display pixels into which an image signal can be written;
a correcting unit configured to correct gray levels of pixels of the image signal for the right eye or the left eye;
a writing unit configured to write the image signal corrected by the correcting unit, into the display pixels of the image displaying unit; and
a timing controlling unit configured to control timing to open and close the right and the left of the glasses in accordance with timing of the writing by the writing unit, wherein
the correcting unit corrects the gray levels of the pixels of the image signal in accordance with a difference between the timing of the writing by the writing unit and the timing to open and close the right and the left of the glasses.

2. The apparatus according to claim 1, wherein the correcting unit corrects the gray levels of the pixels of the image signal, based on gray levels of pixels of at least one of 1 to “N” (“N” being an integer of 1 or greater) image signals to be displayed prior to the image signal.

3. The apparatus according to claim 2, wherein the correcting unit corrects the gray levels of the pixels so that a difference between a predetermined expectation value and a total integrated intensity becomes smallest or less than or equal to a threshold value, the total integrated intensity obtained for each of the displayed pixels by integrating products of (a) display luminance of the displayed pixel and (b) the light transmittances for the right eye and the left eye in a certain period and summing up the integrated products.

4. A stereoscopic image displaying apparatus that displays a stereoscopic image to a viewer wearing glasses, comprising:
a liquid crystal displaying unit having a plurality of liquid crystal pixels into which an image signal can be written;
a correcting unit configured to correct gray levels of pixels of an image signal for the right eye or the left eye;
a backlight configured to emit light wherein the liquid crystal displaying unit modulates the light from the backlight, based on the image signal written into the liquid crystal pixels;
a writing unit configured to write the image signal corrected by the correcting unit, into the liquid crystal pixels of the liquid crystal displaying unit; and
a timing controlling unit configured to control timing of the light emission from the backlight and timing to open and close the right and the left of the glasses in accordance with timing of the writing by the writing unit, wherein
the correcting unit corrects the gray levels of the pixels of the image signal so that a difference between a predetermined expectation value and a total integrated intensity becomes smallest or less than or equal to a threshold value, the total integrated intensity being obtained for each of the displayed liquid crystal pixels by integrating products of (a) liquid crystal transmittance of the liquid crystal pixel, (b) emission luminance of the backlight, and (c) light transmittances for the right eye and the left eye in a certain period and summing up the integrated products.

5. The apparatus according to claim 4, wherein
the backlight includes a plurality of light emitting units each being capable of switching between emission and non-emission,
the timing controlling unit controls timing of light emission of the light emitting units, and
the correcting unit corrects the gray levels of the pixels so that a difference between a total integrated intensity and the predetermined expectation value becomes smallest, the total integrated intensity being obtained for each of the liquid crystal pixels, based on light distribution on the liquid crystal displaying unit at the time when each of the light emitting units emits light to the liquid crystal displaying unit, by integrating products of (a) a total light intensity on the liquid crystal pixel by the light emitting units, (b) the liquid crystal transmittance of the liquid crystal pixel, and (c) the light transmittances for the right eye and the left eye in a certain period and summing up the integrated products.

6. The apparatus according to claim 5, wherein the predetermined expectation value is the total integrated intensity in a case where a liquid crystal response of the liquid crystal pixel has a step response.
